(19) United States
(12) Patent Application Publication
(10) Pub. No.: US 2018/0027037 A1
(43) Pub. Date: Jan. 25, 2018

(54) MOBILE DEVICE-BASED CONTENT LOADER FOR ENTERTAINMENT SYSTEM

(71) Applicant: Panasonic Avionics Corporation, Lake Forest, CA (US)

(72) Inventors: Philip Watson, Lake Forest, CA (US); Steven Bates, Mission Viejo, CA (US); Amir Ali Mirmirani, Mission Viejo, CA (US)

(21) Appl. No.: 15/402,947

(22) Filed: Jan. 10, 2017

Related U.S. Application Data
(63) Continuation-in-part of application No. 15/217,860, filed on Jul. 22, 2016.

(51) Int. Cl. H04L 29/06; H04W 84/12; H04L 29/08

(52) U.S. Cl. CPC H04L 65/60; H04L 67/1097; H04W 84/12; H04L 67/12; H04B 7/18506

(57) ABSTRACT

A system for wirelessly distributing multimedia content to an in-flight entertainment system includes a remote content server on which the multimedia content is stored. One or more content loader devices are each associated with an individual scheduled for travel on an aircraft, and each of the content loader devices has a data retrieval module that initiates a transfer of partitions of the multimedia content upon establishing a first data communications link to the remote content server, and a data loading module that transfers the multimedia content to the in-flight entertainment system over a second data communications link to the in-flight entertainment system. The remote content server defines and designates the partitions for transfer to a specific one of the content loader devices based at least in part upon a predefined association between the content loader device and the aircraft.

### CROSS-REFERENCE TO RELATED APPLICATIONS

This application is a continuation-in-part patent application of co-pending U.S. patent application Ser. No. 15/217,860 filed Jul. 22, 2016 and entitled “CREW MOBILE DEVICE-BASED CONTENT LOADER FOR ENTERTAINMENT SYSTEM,” the disclosure of which is wholly incorporated by reference in its entirety herein.

### STATEMENT RE: FEDERALLY SPONSORED RESEARCH/DEVELOPMENT

Not Applicable

### BACKGROUND

### 1. Technical Field

The present disclosure relates generally to data communications devices, and more particularly, to mobile device-based content loaders for vehicle entertainment systems.

### 2. Related Art

Air travel typically involves journeys over extended distances that at the very least take several hours to complete. Some of the longer non-stop international flights have scheduled durations of over sixteen hours with travel distances extending beyond ten thousand miles. Passengers on board the aircraft are confined within an enclosed space of a designated seat for the entire duration of the flight, with only a few limited opportunities to leave the seat for use of the lavatory and so forth. Thus, even on the shortest trips an airline passenger has some idle time, which the passenger may occupy with work, leisure, and/or rest.

Many passengers bring their own personal electronic devices such as smart phones, media players, electronic readers, tablets, laptop computers, and so forth, for the express purpose of keeping occupied, but airlines also accommodate its customers with in-flight entertainment and communications (IFEC) systems. Although the specific installation may vary depending on the service class, each passenger seat is equipped with a display device, an audio output modality, an input modality such as a remote control, and a terminal unit. Generally, the terminal unit may generate video and audio signals, receive inputs from the remote control, and execute pre-programmed instructions in response thereto. The display device is typically an LCD screen that is installed on the seatback of the row in front of the passenger, though in some cases it may be mounted to a bulkhead or retractable arm or the like that is in turn mounted to the passenger's seat. Furthermore, the audio output modality is a headphone jack, to which a headphone, either supplied by the airline or by the passenger, may be connected.

Via the display and the audio outputs, a wide variety of multimedia content can be presented to the passenger. Recently released movies are a popular viewing choice, as are television shows such as news programs, situation and stand-up comedies, documentaries, and so on. Useful information about the destination such as airport disembarking procedures, immigration and custom procedures and the like is also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger using the remote control, which may also have alternative uses, namely, for navigating through the vast multimedia content library and making selections thereof for viewing and/or listening. Thus, the terminal unit may also include a content selection application with a graphical user interface, through which such navigation of the multimedia content library is possible. The foregoing types of programming that can be presented to the passenger via the in-flight entertainment system will henceforth be generally referred to as multimedia content.

The multimedia content is encoded and stored as digital data, with a video decoder and audio decoder of the terminal unit functioning to generate the aforementioned video and audio signals therefrom. It is desirable to have a wide range of different multimedia content to satisfy the varying tastes of passengers. It is also desirable to have a sufficient volume of multimedia content so that passengers can remain occupied with entertainment for the entire duration of the flight. Accordingly, the multimedia content stored onboard the aircraft can range in the hundreds of gigabytes, if not over a terabyte. The majority of the data comprises the video programming, although the audio and video game content may be significant as well. This data is typically not stored on each individual terminal unit, but rather, in a central content server also onboard the aircraft. In this regard, the terminal unit is understood to incorporate networking modalities such as Ethernet to establish data communications with the central content server. Once a particular selection of multimedia content is requested by the passenger via the content selection application, the terminal unit may retrieve the same from the central content server, decode the data, and present it to the passenger.

As important as variety and volume may be in regards to the multimedia content, novelty is as important for airlines to keep its passengers engaged with the in-flight entertainment system, particularly for valuable frequent fliers. Thus, the multimedia content stored on the content server must be frequently updated. Due to the large volume of data involved, a portable content loader that is generally comprised of a hard disk drive, an optical drive, or a solid state drive loaded with the update data is physically carried onboard while the aircraft is on the ground and connected to the central content server. A download or copy process is then initiated, and once complete, the portable content loader is disconnected and removed from the aircraft.

In part because of the laborious manual procedures involved, this update process typically takes place on a monthly schedule, preferably during a layover between flights, such as when aircraft maintenance is conducted. It would be desirable for new multimedia content to be made available on a more frequent basis, incorporating programming that may be only days or even a few hours old. Yet, the expense and labor involved with the use of specialized content loader devices may preclude this. These issues are particularly acute for large fleets of aircraft.

Aircraft-installed content loaders that utilize wireless networking for multimedia content retrieval have been developed to address this need for updated content. Such data loaders are powered directly from the aircraft electrical system, and hence only operate while the aircraft is powered on. Wi-Fi, as well as cellular communications modalities are utilized in such content loaders. However, these typically require the aircraft to be parked near the gate, where a Wi-Fi access point or a cellular link is available. The time between each flight during which the aircraft has access to a ground-based Wi-Fi access point or cellular link may be limited, so the amount of content that can be updated may likewise be limited; by most measures, an aircraft spends at most one tenth of its operational life on the ground. Although Wi-Fi access is the least costly because there are no usage charges, setting up an access point at every airport, and for every terminal in the airport at which the aircraft may stop, requires setting up a substantial ground-based infrastructure. Cellular communications, on the other hand, typically have usage costs as well as roaming charges to the extent the aircraft is located in a non-native coverage area.

While satellite downlink-based loaders are also known in the art, a separate, dedicated antenna(s) that typically utilize phased array technology must be installed on the aircraft exterior. There are additional power requirements for such satellite modalities as well, and bandwidth is both limited and costly.

Accordingly, there is a need in the art for an improved content loader device to the in-flight entertainment systems across a fleet of aircraft. There is a need for a mobile device-based content loader for the in-flight entertainment system.

### BRIEF SUMMARY

The present disclosure contemplates a content loader for an entertainment system of a vehicle that utilizes personal electronic devices (PEDs) of passengers and crewmembers alike.

In accordance with one embodiment, a content loader device for transferring multimedia content from a remote content server to an entertainment system of a vehicle is disclosed. The content loader device may include a content memory. Additionally, the content loader device may include a primary data networking module that establishes a local data transfer link to the entertainment system while being within direct wireless communicable range thereto. The primary data networking module may also establish a primary remote data transfer link to the remote content server while being beyond direct wireless communicable range to the entertainment system. The content loader device may further include a data retrieval client that is linked to the content memory and the primary data networking module. The data retrieval client may initiate a retrieval of the multimedia content over the primary remote data transfer link based at least in part upon a predefined association of the content loader device to the vehicle. The retrieved multimedia content may be stored in the content memory. The content loader device may also include a data loading client that is linked to the content memory and the primary data networking module. The data loading client, in response to a detected establishment of the local data transfer link, may transfer the multimedia content to the entertainment system following retrieval from the content memory.

According to another embodiment of the present disclosure, there is a system for wirelessly distributing multimedia content to an in-flight entertainment system of an aircraft. The system may include a remote content server on which the multimedia content is stored. The multimedia content may be segregated into one or more partitions. Additionally, the system may include one or more content loader devices each associated with an individual scheduled for travel on the aircraft. Each of the content loader devices may include a data retrieval module that initiates a transfer of the one or more partitions of the multimedia content upon establishing a first data communications link to the remote content server. The content loader devices may also include a data loading module that transfers the multimedia content to the in-flight entertainment system over a second data communications link to the in-flight entertainment system. The remote content server may define and designate the one or more partitions of the multimedia content for transfer to a specific one of the content loader devices based at least in part upon a predefined association between the specific one of the content loader devices and the aircraft.

Yet another embodiment of the present disclosure is directed to a method for distributing multimedia content to an in-flight entertainment system of an aircraft. The method may include establishing a first data transfer link from a content loader device to a content server computer system. There may be a step of receiving a stream of secondary multimedia content from a streaming server computer system. The stream may be received on the content loader device over a content streaming link. The method may further include instructing the content server computer system to generate one or more partitions of a multimedia content in response to initiating the streaming of the secondary multimedia content to the content loader device. The generating of the one or more partitions may be based at least in part upon a predefined association between the content loader device and the in-flight entertainment system of the aircraft. The method may also include receiving the partitions of the multimedia content generated by the content server computer system by the content loader device. There may also be a step of transmitting the one or more partitions of the multimedia content to the in-flight entertainment system over a second data transfer link from the content loader device to the in-flight entertainment system.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of an exemplary aircraft environment in which one aspect of the presently disclosed content loader may be utilized;

FIG. 2 is a block diagram showing the various components of a first embodiment of a system for wirelessly distributing multimedia content to an in-flight entertainment system;

FIG. 3 is detailed block diagram illustrating the first embodiment of the system for wirelessly distributing multimedia content, including the features of a remote content server, a content loader device, and the in-flight entertainment system;

FIG. 4 is an exemplary data structure diagram of a segment of multimedia content that is transferred from the remote content server to the content loader device, and then to the in-flight entertainment system;

FIGS. 5A and 5B are flowcharts depicting one embodiment of a method for wirelessly distributing content to the in-flight entertainment system;

FIG. 6 is a block diagram showing the various components of a second embodiment of a system for wirelessly distributing multimedia content to an in-flight entertainment system;

FIG. 7 is detailed block diagram illustrating the second embodiment of the system for wirelessly distributing multimedia content, including the features of a remote content server, a content loader device, and the in-flight entertainment system; and

FIG. 8 is a flowchart depicting another embodiment of the method for wireless distributing content to the in-flight entertainment system.

### DETAILED DESCRIPTION

The present disclosure is directed to wireless content loaders for vehicle entertainment systems, such as an in-flight entertainment for an aircraft. The detailed description set forth below in connection with the appended drawings is intended as a description of the presently preferred embodiments of the content loader, and is not intended to represent the only form in which it can be developed or utilized. The description sets forth the features of the content loader in connection with the illustrated embodiments. It is to be understood, however, that the same or equivalent functions may be accomplished by different embodiments that are also intended to be encompassed with the present disclosure. It is further understood that the use of relational terms such as first, second, and the like are used solely to distinguish one from another entity without necessarily requiring or implying any actual such order or relationship between such entities.

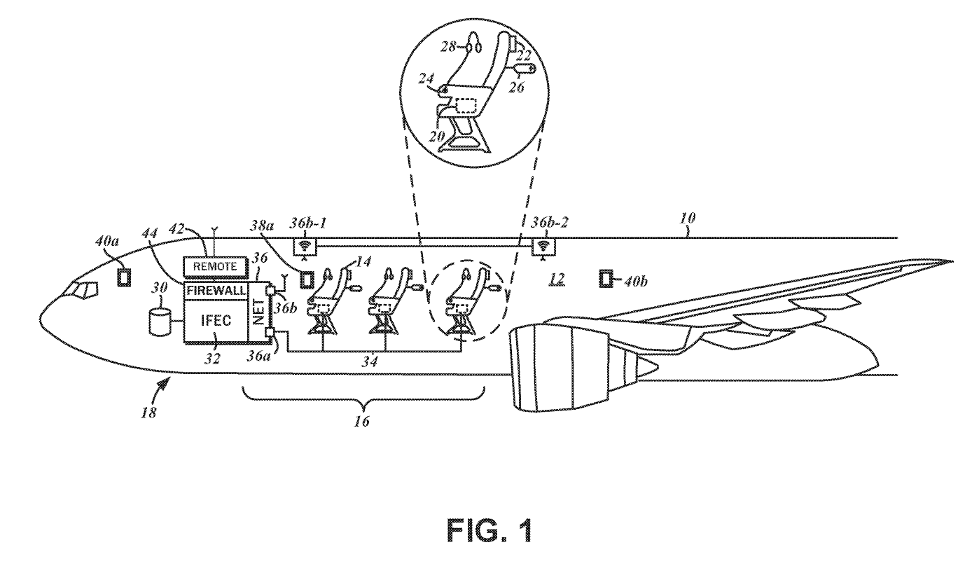

The diagram of FIG. 1 depicts an exemplary aircraft 10 in which various embodiments of the presently disclosed content loader may be implemented. Within a fuselage 12 of the aircraft 10 there are seats 14 arranged over multiple rows 16, and each seat 14 accommodating a single passenger. Although the features of the present disclosure will be described in the context of the passenger aircraft 10 and amenities therefor, other passenger vehicles such as trains, watercraft, buses, and others utilizing integrated entertainment systems may be substituted.

The aircraft 10 incorporates an in-flight entertainment and communications (IFEC) system 18, through which various entertainment and connectivity services may be provided to passengers while onboard. A typical IFEC system 18 includes individual seat-back modules comprised of a terminal unit 20, a display 22, an audio output 24, and a remote controller 26. For a given row 16 of seats 14, the terminal unit 20 and the audio output 24 are disposed on the seat 14 for which it is provided, but the display 22 and the remote controller 26 may be disposed on the row 16 in front of the seat 14 to which it is provided. That is, the display 22 and the remote controller 26 are installed on the seatback of the row in front of the seat. This is by way of example only, and other display 22 and remote controller 26 mounting and access configurations such as a retractable arm or the like mounted to an armrest of the seat 14 or by mounting on a bulkhead.

The display 22 is understood to be a conventional liquid crystal display (LCD) screen with a low profile that is suitable for installation on the seatback. Each passenger can utilize an individual headset 28, supplied by either the airline or by the passenger, which provides a more private listening experience. In the illustrated embodiment, the audio output 24 is a headphone jack that is a standard ring/tip/sleeve socket. The headphone jack may be disposed in proximity to the display 22 or on the armrest of the seat 14 as shown. The headphone jack may be an active type with noise canceling and including three sockets or a standard audio output without noise canceling. In alternate embodiments, each display 22 may incorporate a terminal unit 20 to form a display unit referred to in the art as a smart monitor.

A common use for the terminal unit 20 installed on the aircraft is the playback of various multimedia content. The terminal unit 20 may be implemented with a general-purpose data processor that decodes the data files corresponding to the multimedia content and generates video and audio signals for the display 22 and the audio output 24, respectively. This multimedia content may include movies, television shows, such as news programs, comedy, documentaries, and informational content pertinent to the flight destination. Furthermore, multimedia content may also encompass audio-only programming, as well as interactive games, flight progress mapping, flight status displays, newspapers/magazines readable on the display 22, and so on. Broadly, multimedia content is intended to refer to any content of varying duration and form that can be presented to the passenger via the display 22 or the audio output 24, or a combination thereof.

The data files of the multimedia content may be stored in a database 30 associated with the IFEC system 18. Specifically, the database 30 is connected to and managed by an IFEC server 32, which may be a specifically adapted general purpose computer system configured as a server to provide data in response to requests therefor. Various software modules are understood to be incorporated into the IFEC server 32, including a streaming server that retrieves the multimedia content from the database 30, as well as a cataloging/menu application with which the user interacts to select the desired multimedia content.

The passenger can play games being executed on the terminal unit and otherwise interact with the multimedia content with the remote controller 26. Navigating through the vast multimedia content library and selecting ones for viewing and/or listening is also possible with the remote controller 26, though in some embodiments, a touch-screen display may be provided for a more intuitive interaction with the multimedia content library. In either case, the terminal unit 20 is loaded with a content selection software application that is executed by the data processor and accepts input from the remote controller 26 or other input modality and generates a response on the graphical interface presented on the display 22.

Each of the terminal units 20 may be connected to the IFEC server 32 over an aircraft local area network 34, one segment of which may preferably be Ethernet. Thus, the IFEC server 32 includes a data communications module 36, and more specifically, an Ethernet data communications module 36a, e.g., an Ethernet switch or router.

One or more passengers may utilize a portable electronic device (PED) 38 during flight. For purposes of the present disclosure, passenger PEDs 38 refer to smart phones, tablet computers, laptop computers, and other like devices that include a general purpose data processor that executes pre-programmed instructions to generate various outputs on a display, with inputs controlling the execution of the instructions. Although these devices are most often brought on board the aircraft 10 by the passengers themselves, carriers may also offer them to the passengers for temporary use.

In addition to the passengers bringing the PEDs 38 on board for entertainment or productivity use, flight crew and cabin crew may likewise employ computing devices to carry out their respective duties during flight. For instance, the flight crew may utilize a crewmember PED 40a as an electronic flight bag (EFB). The cabin crew may be issued a crewmember PED 40b that is loaded with specific applications for managing cabin operations. Henceforth, the flight crew electronic flight bag and the cabin crew-issued devices will be referred to as crewmember PEDs 40, which are understood to encompass smart phones, tablet computer, laptop computers, and so forth.

Almost all conventional PEDs 38, 40 have a WLAN (Wi-Fi) module. In order to provide on-board connectivity, the data communications module 36 of the IFEC server 32 also includes a WLAN access point 36b. The PEDs 38, 40, via the onboard WLAN network, may connect to the IFEC server 32 to access various services offered thereon such as content downloading/viewing, shopping, and so forth.

Typically, a single WLAN access point 36b is insufficient for providing wireless connectivity throughout the cabin, so additional WLAN access points 36b-1 and 36b-2 may be installed at various locations spaced apart from each other. These additional WLAN access points 36b-1 and 36-b2 may be connected to the IFEC server 32 over an Ethernet link that is part of the aforementioned aircraft local area network 34. The local area network interface or data communications module 36 is understood to encompass the hardware components such as the WLAN access point 36b/transceiver and the Ethernet router/switch 36a, as well as the software drivers that interface the hardware components to the other software modules of the IFEC server 32.

The IFEC system 18 may also offer Internet access to the connecting terminal units 20 as well as the PEDs 38, 40 during flight. In this regard, the IFEC server 32 may include a remote communications module 42 that establishes a remote data uplink, which in turn is connected to the Internet. The remote data uplink may be to a satellite, utilizing Ku-band microwave transmissions. Alternative satellite communications systems such as Inmarsat or Iridium may also be utilized. In another embodiment, the remote communications module 42 may be a cellular modem. The terminal unit 20 or the PEDs 38, 40 connect to the IFEC server 32 via the aircraft local area network 34 established by the data communications module 36, which relays the data transmissions to the remote communications module 42. Due to the high costs associated with the communications satellite or cellular networks in roaming mode, carriers may limit data traffic to and from the remote communications module 42 with a firewall 44.

The foregoing arrangement of the IFEC system 18, along with its constituent components, have been presented by way of example only and not of limitation. Those having ordinary skill in the art will recognize that the IFEC system 18 and its functional subparts can be arranged and organized in any number of different configurations. Furthermore, there may be additional components not mentioned herein, and certain functions may be handled by a different subpart or component than that to which the present disclosure attributes.

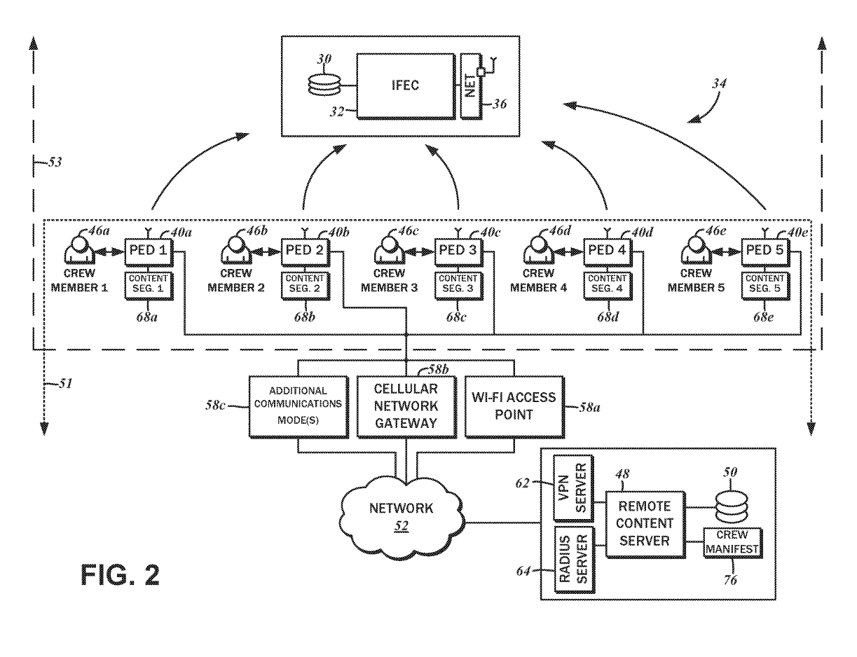

As mentioned above, there is a need to update the IFEC system 18 with new multimedia content from time to time, and the present disclosure contemplates various modalities to this end. With reference to the block diagram of FIG. 2, per typical practice, the aircraft 10 is staffed with various crewmembers 46, including a first crewmember 46a, a second crewmember 46b, a third crewmember 46c, a fourth crewmember 46d, and a fifth crewmember 46e. Although no distinction is made herein with respect to the nature of the duties of each crewmember 46, they may generally be classified as flight crew that operate the aircraft, or cabin crew that help maintain the safety and comfort of passengers in the cabin. In some cases, the crewmember 46 may also include ground crew that provide aircraft maintenance services. The number of crewmembers 46 shown in FIG. 2 is by way of example only and not of limitation, and different flights have more or less crewmembers 46.

Each of the crewmembers 46a-46e are issued a respective crewmember PEDs 40a-40e, that is, the first crewmember 46a is assigned a first crewmember PED 40a, the second crewmember 46b is assigned a second crewmember PED 40b, the third crewmember 46c is assigned a third crewmember PED 40c, the fourth crewmember 46d is assigned a fourth crewmember PED 40d, and a fifth crewmember 46e is assigned a fifth crewmember PED 40e. In the presently contemplated system for distributing multimedia content, the crewmember PEDs 40a-40e need not be uniform with respect to the hardware device or the operating platform, though they are each understood to be capable of executing pre-programmed software instructions that implement various features of the system as will be described in further detail below. As indicated above, the crewmember PEDs 40 are configured with wireless data communications/networking modalities including Wi-Fi, which may be used to connect to an aircraft local area network 34 established by the data communications module 36 of the IFEC system 18.

A first embodiment of the present disclosure contemplates the use of the crewmember PEDs 40 to retrieve updates to the multimedia content from a central repository while away from the aircraft 10, and once the crewmembers 46, by which such PEDs 40 are possessed, are onboard, in physical proximity to the aircraft 10 or in direct wireless communicable range to the data communications module 36 of the IFEC system 18, the multimedia content is transferred thereto. That is, the crewmember PEDs 40 are being utilized as a content loader. This transfer is understood to take place transparently and in the background during flight operations (whether on the ground or during flight) using the aircraft local area network 34.

As shown in FIG. 2, the aforementioned central repository of updated multimedia content may be implemented as a remote content server 48 that includes a content storage database 50. It is understood that the remote content server 48 is a conventional server computer system that is connected to a wide area network 52, to which the crewmember PEDs 40 also connects over various network modalities. According to one embodiment, the wide area network is the Internet, though any other suitable network may be substituted without departing from the scope of the present disclosure.

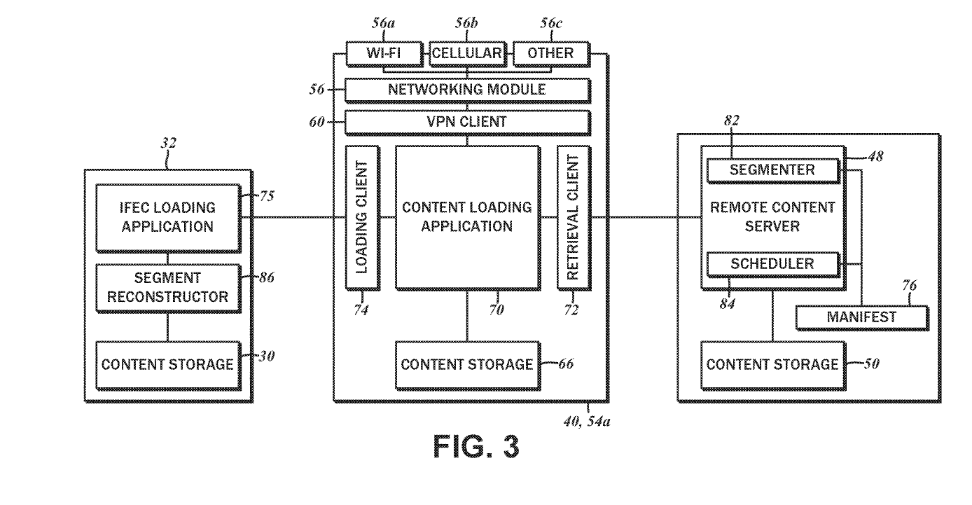

With reference to the block diagram of FIG. 2, the crewmember PEDs 40 establish a connection to the remote content server 48 when outside the direct wireless communicable range to the IFEC system 18 via one of several modalities, which is depicted as an area 51. As shown in FIG. 3, the crewmember PED 40, which is also referred to as a first embodiment of a content loader 54a, includes a data networking module 56 that implements the various physical and electrical interfaces of the communications modalities, as well as the software protocol stacks of the same. The data networking module 56 can be segregated into different submodules that correspond to the communications modalities, including a Wi-Fi module 56a, a cellular module 56b, and other modules 56c. These modules of the content loader 54a are understood to connect to corresponding access points that serve as a gateway to the wide area network 52. Referring again to FIG. 2, this includes a Wi-Fi access point 58a, a cellular network gateway 58b, and an access point for other communications modules 58c.

The Wi-Fi module 56a and the Wi-Fi access point 58a to which it connects implements the physical interfaces and protocol stacks as defined under the Institute of Electrical and Electronics Engineers (IEEE) 802.11 standards, also known in the art as WLAN. To ensure compatibility with all possible Wi-Fi access points that may be encountered, the Wi-Fi module 56a is understood to have both 2.4 GHz and 5 GHz modes, and implement all existing 802.11 standards, including a, g, n, and ac protocols. The Wi-Fi module 56a may be connected to one or more antennas, and preferably three so that 3×3 MIMO (Multiple-In, Multiple-Out) Operation is possible. The Wi-Fi module 56a may also be referred to as a primary data networking module in some embodiments. In such embodiments, the Wi-Fi module 56a is utilized to connect to both the IFEC system 18 as well as the remote content server 48.

The second communications modality, as mentioned above, is cellular/mobile communications. A wide variety of technologies and standards for cellular data communications are deployed around the world, and to ensure interoperability, the cellular module 56b may be configured for different cellular technologies/technology families. One such cellular technology is GSM/EDGE (Global System for Mobile Communications/Enhance Data Rates for GSM Evolution). The data service of EDGE is also referred to as GPRS (General Packet Radio Service), and is likewise implemented in cellular module 56b. The latest advancement is also referred to as 4G LTE (Long Term Evolution), and a layer-1 data rate up to 500 Mbit/s is envisioned.

There are two existing transmission technologies with LTE—Frequency Division Duplex (FDD) and Time Division Duplex (TDD). Different countries have varying frequency allocations, so the cellular module 56b is configured for different FDD transmissions between the 700 MHz band and the 2600 MHz band, including the 700 MHz band, the 800 MHz band, the 900 MHz band, the 1800 MHz band, the 1900 MHz band, and the 2100 MHz band in particular. Earlier GSM-based systems such as UMTS (Universal Mobile Telecommunications System) with operating frequencies in the 850 MHz band, the 900 MHz band, the 1900 MHz band, and the 2100 MHz band may also supported. Furthermore, operation in the AWS band and the 800 MHz band may be possible.

An alternative cellular technology that may also be implemented in the cellular module 56b is W-CDMA (Wideband Code Division Multiple Access), the third generation (3G) data service component of which is known in the art as HSPA+(Evolved High Speed Packet Access). The cellular module 56b of the content loader 54a is understood to connect to the cellular network gateway 58b to access the wide area network 52.

Another communications mode of the content loader 54a may conform to IEEE 802.16 standards (frequently referred to as WiMAX) or other standard such as WiBro that is common in South Korea, or other proprietary standard. The submodule of the data networking module 56 implemented in the content loader 54a for such alternative communications mode is identified as other modules 56c, while the access point to which such module connects being shown in FIG. 2 as other communications modules 58c.

Regardless of whether Wi-Fi, cellular network, or other modalities are utilized to establish the data transfer link with the remote content server 48, in some embodiments, all transmissions between the content loader 54a and the remote content server 48 may take place over a virtual private network (VPN). To this end, as shown in the block diagram of FIG. 3, the content loader 54a may include a VPN client 60, and there may be a corresponding VPN server 62 at the remote content server 48.

The virtual private network encrypts all data traffic between the content loader 54a and the remote content server 48, and is understood to be Cisco IPSec-compliant. Different implementations of VPN may be utilized, with multiple VPN tunnels being supported. Different cryptographic functions to ensure data integrity such as SHA-1 (secure hash algorithm), MD5, and RSA may be provided, and multiple encryption modalities are contemplated, including DES, 3DES, and AES. Authentication may be performed over the RADIUS (Remote Authentication Dial In User Service) protocol to an existing remote RADIUS server 64.

Securing the transmissions between the content loader 54a and the remote content server 48 with the VPN is presented by way of example only and not of limitation. Any other network security modality may be substituted without departing from the scope of the present disclosure.

Again, the first embodiment of the content loader 54a retrieves updates of the multimedia content stored on the remote content server 48 when it is outside the wireless communication range of the IFEC system 18, and when the various access points 58 are available. In the exemplary context of airline transport, the crewmembers 46 are understood to have layovers of varying durations between flights on which they are assigned. Some layovers are of relatively short duration typically in the range of a few hours. In such case, the content loader 54a or crewmember PED 40 may establish a connection to an airport Wi-Fi access point to connect to the wide area network 52 and eventually to the remote content server 48. Other layovers, particularly with international flights, may be much longer, typically in the range of a day or more. In this case, the content loader 54a or crewmember PED 40 may establish a connection to a hotel Wi-Fi access point to connect to the wide area network 52. Alternatively, should a Wi-Fi access point be unavailable, the cellular networks may be utilized. Which communications modality to be used may depend on the specific location and whether expensive roaming charges would apply, and the default selection of the communications modality may be set within the operating system of the crewmember PED 40. The use of both Wi-Fi and cellular modalities is also possible.

As shown in the block diagram of FIG. 3, the content loader 54a/crewmember PED 40 is understood to include a content storage 66, also referred to herein as a content memory. Upon connecting to the remote content server 48, updates to the multimedia content may be downloaded and temporarily saved in the content storage 66 for subsequent transfer to the IFEC system 18.

In accordance with various embodiments of the present disclosure, it is also possible to distribute different segments 68 or partitions of the multimedia content across multiple content loaders 54a. The example of FIG. 2 illustrates five crewmembers 46a-46e, which each assigned crewmember PEDs 40a-40e, respectively. The content storage 66 of each of the crewmember PEDs 40 is understood to have a fifty (50) gigabyte capacity. Each of the crewmember PEDs 40 may be loaded with a different unique segment of the multimedia content. That is, the first crewmember PED 40a may store a first segment 68a of the multimedia content, the second crewmember PED 40b may store a second segment 68b of the multimedia content, the third crewmember PED 40c may store a third segment 68c of the multimedia content, the fourth crewmember PED 40d may store a fourth segment 68d of the multimedia content, and the fifth crewmember PED 40e may store a fifth segment 68e of the multimedia content.

With five crewmember PEDs 40 that are brought on board the aircraft 10, a total of two hundred and fifty (250) gigabytes may be loaded on to the IFEC system 18 during one flight leg. As such, it is possible to load one terabyte of data within four flight legs, which corresponds to approximately two days for a long haul aircraft. Conventionally, monthly updates are provided four days in advance, so adherence to this schedule is possible with the presently contemplated embodiments of the content loaders 54a, and can also be improved. Data uploads of smaller increments is possible, rather than one large single-session update. Alternatively, the monthly content update (which may be as large as one terabyte) may be extended over the entire month, requiring incremental updates of only thirty five (35) gigabytes each session. This size is well within the capacity of most existing crewmember PEDs 40.

Besides the capacity of the content storage 66 on the crewmember PED 40, another limitation may be the available time and/or bandwidth needed to download file sizes up to fifty (50) gigabytes. With content updates spaced out over the span of an entire month, thirty five (35) gigabytes per day is typical for a one terabyte monthly update schedule. With five crewmembers, each crewmember PED 40 stores and updates seven (7) gigabytes in each segment 68 of the multimedia content, which is understood to be a reasonable demand for overnight downloads.

Referring to the block diagram of FIG. 3, in addition to the foregoing data communications components, the first embodiment of the content loader 54a is understood to include a content loading application 70 that may be implemented as a set of computer-executable instructions that performs functions in accordance with the various aspects of the present disclosure. In further detail, the content loading application 70 may include a data retrieval client 72 that interfaces with the remote content server 48. The content loading application 70 also includes a data loading client 74 that interfaces with the IFEC server 32, and specifically an IFEC loading application 75 running thereon.

Although the present disclosure refers to the crewmember PED 40 and the content loader 54a interchangeably, the definitions thereof are not intended to be co-extensive. That is, the content loader 54a may also be a dedicated device with the aforementioned content memory and a processor pre-programmed with instructions that embody the content loading application 70 including the data retrieval client and the data loading client 74. Such a device may be brought on board by a selected ground crewmember during ground maintenance/flight preparation procedures in between flights. Like the counterpart crewmember PEDs 40, the content loader 54a may include a battery that is charged at a docking station when not in use, as well as connect to the remote content server 48 to download the multimedia content as needed for the next assigned aircraft/flight. Additionally, as will be described in further detail below, a second embodiment of the content loader may be a passenger PED 38.

The data retrieval client 72, without user intervention and in response to detecting the establishment or existence of the primary remote data transfer link to the remote content server 48, transmits a content reception availability command to the remote content server 48. This is understood to be automated and occurs in the background without the crewmember 46 being prompted. There may be embodiments, however, where an alert is generated upon establishing the network link, followed by a request to provide an input as to whether the content updates are to proceed or not. A default of either proceed or not proceed may be set for such prompt, where a lack of a response defaults to one course of action or another. The content reception availability command may take a variety of forms, including a specific command that is received and processed by the remote content server 48, as well as a flag that is set in an application programming interface to the data retrieval client 72 and occasionally queried from the remote content server 48.

In response to the content reception availability command, the remote content server 48 transmits selected multimedia content to the data retrieval client 72. The identity of the crewmember PED 40/content loader 54a may be included in the content reception availability command to indicate to the remote content server 48 the crewmember 46 with which the crewmember PED 40 is associated. In some embodiments, the particular crewmember 46 and/or the crewmember PED 40 associated therewith is tracked in a crewmember manifest 76, along with aircraft or flight assignments for each crewmember. Thus, when a particular crewmember PED 40 establishes a connection to the remote content server 48, it is possible for the remote content server 48 to determine the next aircraft to which the crewmember PED 40 will be connected, along with which specific multimedia content is to be transferred thereto. To the extent there are multiple crewmembers 46, the remote content server 48 segments the multimedia content into multiple parts, with each part being designated for a particular crewmember PED 40. This function may be performed by a content segmenter 82.

Instead of utilizing the crewmember manifest 76, each crewmember PED 40 may include a home airport designator. Based upon the assumption that one set of crewmembers typically fly together and thus return home together, the remote content server 48 may load the multiple segments 68 of the multimedia content to those crewmember PEDs 40 with the same home airport designator.

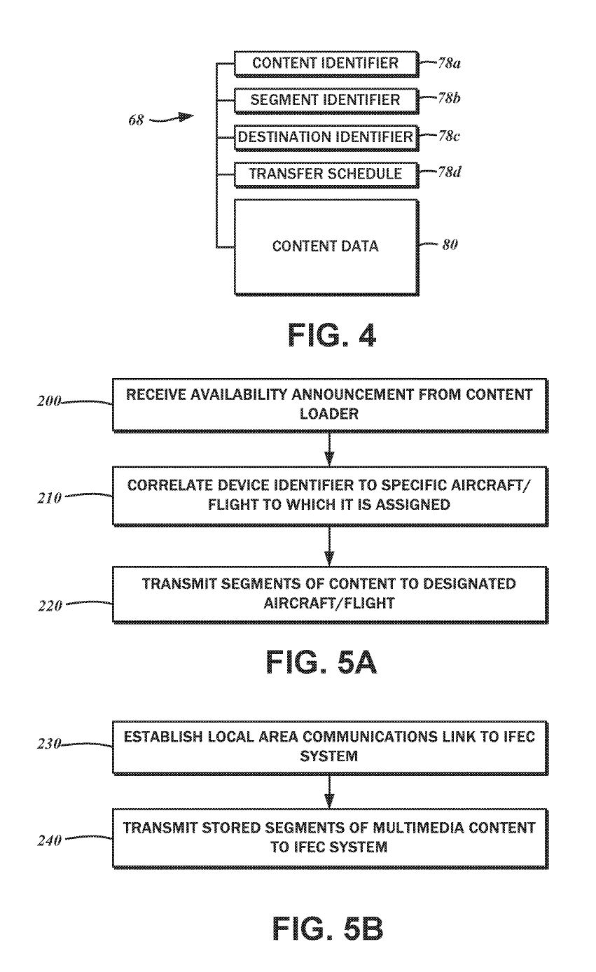

The data structure diagram of FIG. 4 illustrates one contemplated embodiment of a segment 68 of the multimedia content. There is a content identifier field 78a that uniquely identifies the multimedia content, and may be a numeric or alphanumeric character sequence. Furthermore, there is a segment identifier field 78b that identifies the specific segment 68 amongst the sequence of multiple segments. There may also be a destination identifier 78c, which may identify the final destination aircraft 10, the intermediate destination content loader 54, or a combination of both. The values for these fields may be generated by the content segmenter 82. The segment 68 of the multimedia content also includes the content data 80 itself.

The foregoing procedure of connecting to the remote content server 48 and retrieving different segments 68 of the multimedia content is understood to take place independently for each separate crewmember PED 40, and the retrieval of the multimedia content by one crewmember PED 40 is not dependent on another. That is, the remote content server 48 can maintain a listing of all of the separate segments that have been transferred to different crewmember PEDs 40, and to the extent there are no additional crewmember PEDs 40 available to accept the segment, such segment may be queued for a subsequent transfer when a crewmember PED 40 that has already accepted one of the earlier segments again becomes available after completing the last transfer to the IFEC system 18. The order and timing in which the segments 68 are transferred to the multiple content loaders 54 may be set by a scheduler 84.

As noted previously, the content loading application 70 also includes the data loading client 74, which interfaces the content loader 54a to the IFEC server 32. Specifically, the IFEC server 32 includes the IFEC loading application 75 that receives the transmitted segments 68 from the data loading client 74. Again, this transmission is understood to take place over the aircraft local area network 34, and can begin automatically without user invention once the crewmember PED 40 is brought within direct wireless communication range of the aircraft local area network 34, which is depicted as area 53 in the block diagram of FIG. 2. Upon verification of the various fields 78a-c and the completed transfer of the entirety of the content data 80, the IFEC loading application 75 transmits a confirmation to the content loader 54. A more detailed log with entries showing the transferred multimedia content may also be transmitted to the content loader 54 for relaying to the remote content server 48. Along these lines, data to be offloaded from the IFEC system 18 may likewise be transmitted to the content loader for transmission to the remote content server 48. While such data is typically of such a small size that storage space in the memory of the crewmember PED 40 is more than sufficient, if necessary, the IFEC loading application 75 may include a segmenter along the same lines as the content segmenter 82 to distribute such data across multiple content loaders 54. When the content loader 54 connects again to the remote content server 48, the confirmation may be passed thereto so that the same content data is not loaded on the particular IFEC system 18 again, along with the other data mentioned above.

The transmission of one of the segments 68 of the multimedia content to the IFEC server 32 from one content loader 54 is understood to be independent of the transmission of a different segment from another content loader 54. The schedule in accordance with which the transmissions are initiated may be staggered by time, or by flight legs, with such schedule being set by the scheduler 84 and defined within a transfer schedule field 78d in the segment 68. The multiple segments 68 received by the IFEC loading application 75 is then reconstructed by a content reconstructor 86 before the completed multimedia content is stored in the database 30.

The content loader 54, as well as the IFEC server 32 and the remote content server 48 have been described above in terms of the various functional modules thereof. Different embodiments of the content loader 54, the IFEC server 32, and the remote content server 48, while incorporating the same general functional features as described above, may rely upon different components performing different subsets or combinations of such functions. In other words, the features and sub-components of the content loader 54, the IFEC server 32, and the remote content server 48 can be organized along different functional demarcations.

Referring to the flowchart of FIG. 5A, another embodiment of the present disclosure contemplates a method for distributing multimedia content to the IFEC system 18 of the aircraft 10 using crewmember PEDs 40. This method will also be described with reference to the various components and features of the system for distributing multimedia content as shown in FIGS. 2 and 3. There is a step 200 of receiving the first availability announcement from a first content loader 54a/crewmember PED 40a. The first availability announcement, as mentioned above, is transmitted from the content loader 54 to the remote content server 48, and may take any form that enables the remote content server 48 to ascertain that the content loader 54a is ready to receive the multimedia content. The first availability announcement includes a device identifier that is associated with the first content loader 54/crewmember PED 40a.

Next, in a step 210, the first device identifier is correlated to an aircraft identifier that is listed in the crewmember manifest 76 stored in the remote content server 48. Generally, a given aircraft 10 is assigned one or more crewmembers 46, and so the record entries of the crewmember manifest may list each of the aircraft in a carrier's fleet, with the listing of the crewmembers 46 being subsidiary to the record of the aircraft 10 or flight. Alternatively, the manifest may be a flat listing of all of the crewmembers 46 of the carrier, with flight or aircraft assignments being an attribute thereof. Any other data structure of the crewmember manifest 76, along with the appropriate processing steps thereof to correlate the crewmember 46 to a specific aircraft 10 or flight may be substituted without departing from the scope of the present disclosure.

Upon the destination content loader 54 being identified, the method continues with a step 220 of transmitting the one or more segments 68 of the multimedia content thereto. Upon receipt by the first content loader 54/crewmember PED 40a, it may be stored in the content storage 66 thereof.

The foregoing method is described in the context of the remote content server 48, though it will be appreciated that there are corollary steps in the context of the content loader 54a. Another aspect of the disclosed method includes steps that are performed by the content loader 54 in conjunction with the IFEC system 18, and the flowchart of FIG. 5B illustrates such method.

The aforementioned step 220 of transmitting the one or more segments 68 of the multimedia content has a corollary receiving step of the same on the content loader 54. Thereafter, in a step 230, the method includes establishing a local area communications link, e.g., connecting to the aircraft local area network 34 from the content loader 54. Then, there is a step 240 of transmitting the segments 68 of the multimedia content from the content loader 54 to the IFEC system 18.

Each of the foregoing steps may be repeated for a second content loader 54a/crewmember PED 40b, with such steps being executed independently of the first content loader 54a/crewmember PED 40a.

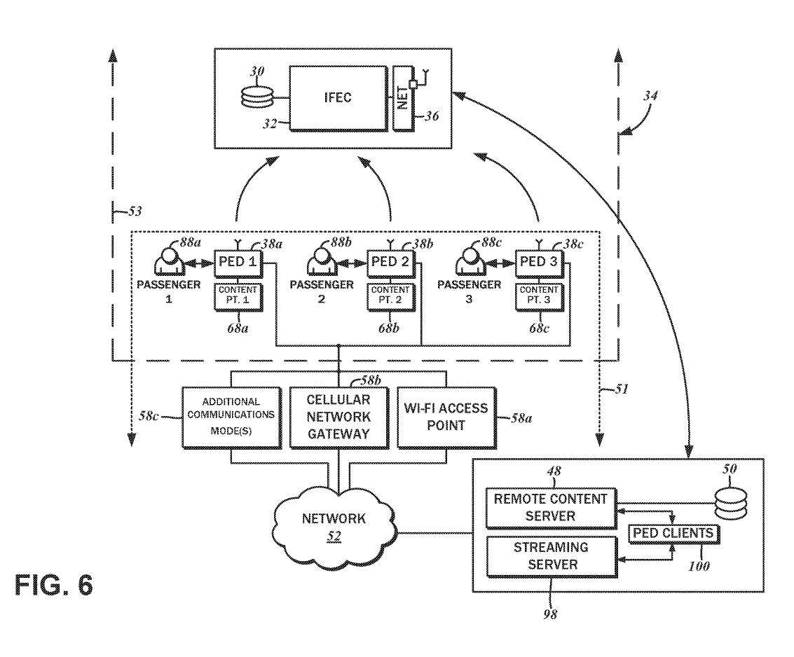

Having considered the first embodiment of the present disclosure in which crewmember PEDs 40 are utilized for distributing the multimedia content, a second embodiment in which the passenger PEDs 38 are utilized to this end will be discussed. With reference to the block diagram of FIG. 6, the aircraft 10 may transport various passengers 88 from one geographic location to another. In the illustrated example, there is a first passenger 88a, a second passenger 88b, and a third passenger 88c, but it will be recognized that a given commercial flight may accommodate tens or hundreds of passengers in the single aircraft 10.

Each of the passengers 88a-88c have respective passenger PEDs 38a-38c, that is, the first passenger 88a has a first passenger PED 38a, the second passenger 88b has a second passenger PED 38b, and a third passenger 88c has a third passenger PED 38c Like the crewmember PEDs 40 discussed above, the passenger PEDs 38a-38c need not be uniform with respect to the hardware device or the operation platform. Each of the passenger PEDs 38a-38c are capable, however, of executing pre-programmed software instructions that implement the various features of the system as will be described in further detail below. The passenger PEDs 38 likewise have wireless data communications and networking modalities including Wi-Fi, and possibly cellular or mobile communications modalities. These modalities may be used to connect to the aircraft local area network 34 established by the data communications module 36 of the IFEC system 18.

In further detail, the second embodiment contemplates that passenger PEDs 38 retrieving updates to the multimedia content from a central repository while away from the aircraft 10, and once the passengers 88, by which such PEDs 38 are possessed, are onboard and/or in physical proximity to the aircraft 10, or in direct wireless communicable range to the data communications module 36 of the IFEC system 18, the multimedia content is transferred thereto. In other words, the passenger PEDs 38 are being utilized as a content loader. This transfer is understood to take place transparently and in the background, whether on the ground or during flight, using the aircraft local area network 34.

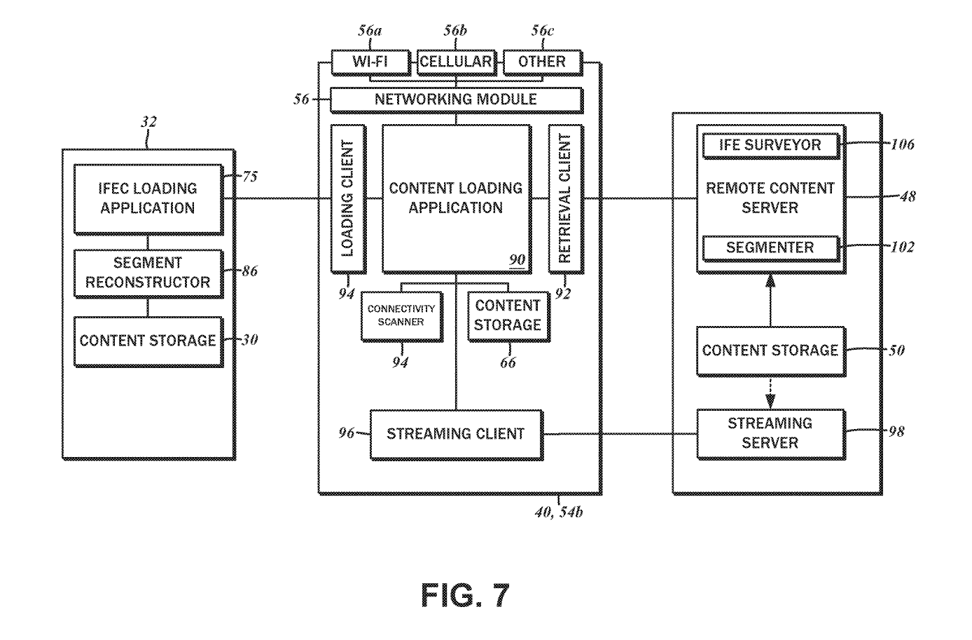

The passenger PEDs 38 establish a connection to the remote content server 48 when outside the direct wireless communicable range to the IFEC system 18 via one of several modalities, which again is depicted as the area 51. As shown in FIG. 7, the passenger PED 38, which is also referred to as a second embodiment of a content loader 54a, includes a data networking module 56 that implements the various physical and electrical interfaces of the communications modalities, as well as the software protocol stacks of the same. The data networking module 56 can be segregated into different submodules that correspond to the communications modalities, including a Wi-Fi module 56a, a cellular module 56b, and other modules 56c. These modules of the content loader 54b are understood to connect to corresponding access points that serve as a gateway to the wide area network 52. Referring again to FIG. 6, this includes a Wi-Fi access point 58a, a cellular network gateway 58b, and an access point for other communications modules 58c, each of which are as described above in relation to the first embodiment shown in FIG. 2. The passenger PED 38 likewise includes the content storage 66 or content memory, and upon connecting to the remote content server 48, updates to the multimedia content may be downloaded and temporarily saved in the content storage 66 for subsequent transfer to the IFEC system 18.

Referring to the block diagram of FIG. 7, a second embodiment of the content loader 54b is understood to be loaded with a different content loading application 90, which may also be implemented as a set of computer-executable instructions that performs functions in accordance with the various aspects of the present disclosure. The content loading application 90 may include a data retrieval client 92 that interfaces with the remote content server 48. The content loading application 90 also includes a data loading client 94 that interfaces with the IFEC server 32, and specifically the IFEC loading application 75 running thereon.

The data retrieval client 92 may initiate the retrieval of the multimedia content from the remote content server 48 over the primary remote data transfer link. Although in most modern operating platforms utilized in PEDs allow applications to run in the background, the duration may be limited, and further, it may be necessary for the application to be invoked or restarted from time to time. In order to encourage the passengers 88 to invoke the content loading application 90, it may be incorporated with additional incentives or functionality.

One contemplated incentive is premium multimedia content along the lines of what is available during flight, such as movies and television programs. In accordance with various embodiments of the present disclosure, the content loading application 90, or at least another application that cooperates with the content loading application 90, may be used by the passenger 88 to view the multimedia content before the flight and even before boarding the aircraft 10 while waiting at the airport terminal. To this end, there is a streaming client 96 that communicates with a streaming server 98 that may similarly be part of the remote content server 48 or at least functionally integrated with the same in certain respects, as will be described more fully below.

Thus, once the content loading application 90 is started by the passenger 88, the various wireless communications modalities accessible at the airport is utilized to establish a data transfer link to the remote content server 48 and the streaming server 98. The passenger 88 may be requested to establish an account with the streaming server 98 so that content preferences, user settings, and the like may be persistently maintained. Additionally, the account may be utilized to identify the specific flight(s) and/or aircraft on which the particular passenger 88 is scheduled for travel. Such data records 100 with this predefined association may be maintained and shared between the remote content server 48 and the streaming server 98, and this predefined association may be set by the passenger 88 in a specific record field within the content loading application 90 for inputting travel itineraries. In the alternative, the content loading application 90 may be provided access to a travel itinerary application also installed on the passenger PED 38 to extract flight information. To the extent an e-mail ticketing confirmation may have been sent from the carrier to the passenger 88, and if the content loading application 90 is provided access to extract itinerary details from an e-mail application running on the passenger PED 38, the particular passenger PED 38, or at least the instance of the content loading application 90 running thereon, can be identified and associated to the specific aircraft 10. The name of the passenger 88 provided to the content loading application 90 may be correlated with an identifier therefor listed in a passenger manifest. Those having ordinary skill in the art will recognize that any other modality of associating the passenger PED 38 to a specific aircraft 10 or flight may be substituted without departing from the scope of the present disclosure.

In addition to defining the association between the passenger PED 38 and the aircraft 10, the data records 100 may also be utilized for monitoring the currently active passenger PEDs 38 that are available for accepting transfers of the multimedia content, and for setting the destination network address for establishing data transfer links. Along these lines, the remote content server 48 separates a large multimedia content file into multiple partitions or segments 68 for piecemeal distribution to the multiple passenger PEDs 38. As illustrated in the block diagram of FIG. 6, where there are three passenger PEDs 38a-38c available, the multimedia content is separated into three parts, a first segment 68a, a second segment 68b, and a third segment 68c. The first segment 68a is transferred to the first passenger PED 38a, the second segment 68b is transferred to the second passenger PED 38b, and the third segment 68c is transferred to the third passenger PED 38c.

In the exemplary embodiment, it is understood that each of the three passenger PEDs 38a-38c invoked the content loading application 90 and the streaming client 96, and thus expressed a willingness to assist in the transfer of multimedia content from the remote content server 48 to the IFEC server 32. As indicated above, the PEDs 38 are associated to the aircraft 10 and the specific IFEC system 18 thereof according to the information stored in the data records 100. The remote content server 48 therefore has updated log of the total number of passenger PEDs 38 that are available to accept segments 68 of the multimedia content. The remote content server 48 may also be provided with scheduling information, e.g., the departure time, of the aircraft 10 to which the foregoing passenger PEDs 38 are associated. Thus, the remaining time available to complete the transfer of any multimedia content with respect to those specific passenger PEDs 38 anticipated to be onboard the aircraft 10 on the flight can be ascertained. From the foregoing information, the appropriate number of segments 68 of the multimedia content to generate, along with the optimal size of such segments 68 may be determined. In the illustrated example of FIG. 6, the first passenger PED 38a is transferred a first segment 68a, the second passenger PED 38b is transferred a second segment 68b, and the third passenger PED 38c is transferred a third segment 68c.

Referring to the block diagram of FIG. 7, the remote content server 48 may include a segmenter 102 to for executing these steps. In addition to the scheduling information, the segmenter 102 may evaluate other factors, such as the processing capabilities of each passenger PED 38, the available memory in the passenger PED 38, the speed of the network access points 58, and so on. Each of the generated segments 68 are understood to be as described above in relation to the first embodiment.

During the transfer of the segments 68 to the passenger PED 38, the streaming server 98 streams secondary multimedia content to the streaming client 96 for immediate viewing on the passenger PED 38, which is contemplated to be the incentive for the passenger PED 38 to be partially utilized as a content loader by the carrier. Thus, the transfer of the multimedia content to be transferred to the IFEC server 32, which may be referred to as the primary content, occurs in the background. The streaming client 96 and the streaming server 98 are understood to be conventional streaming client-server systems well known in the art, so additional details thereof will be omitted. As illustrated in the block diagram of FIG. 7, the secondary multimedia content may be the same as the primary multimedia content, and accordingly may be stored in the content storage 50. Other embodiments in which the secondary multimedia content is separate and separately stored from the primary multimedia content are also possible.

Although in most cases the transfer of the selected segments 68 of the multimedia content takes place in temporal proximity to the scheduled flight, as the latest content not on the aircraft IFEC system 18 are transferred. Accordingly, the passenger PED 38 is likely connected to an airport Wi-Fi network that is immediately accessible upon arriving at the airport, and all the way through to the terminal gate. This is by way of example only and not of limitation, and any other suitable high-speed data network may be utilized. Additional incentives such as miles/points that can be redeemed for travel, service upgrades, and the like may also be offered by the carrier for those passengers 88 permitting the use of the passenger PEDs 38 for higher volume data transfers, or allowing transfers over paid network segments.

Not all of the segments 68 need be transferred to the IFEC server 32 via the passenger PEDs 38. This system may be combined with the features of the first embodiment discussed above, in which the crewmember PEDs 40 are utilized to also transport multimedia content. Furthermore, certain segments 68 may be designated for transfer via satellite communications (Ku-band, etc.), or a ground-based wireless networking modality directly connecting to the aircraft 10, such as cellular/LTE and Wi-Fi.

Once a bi-directional communication link is made between the remote content server 48 and the data retrieval client 92, the transfer of the segments 68 of the multimedia content is initiated. Upon receipt, the segments 68 are stored in the content storage 66. The content loading application 90 further includes a connectivity scanner 104 that seeks out a connection to the IFEC server 32, and specifically the IFEC loading application 75 running thereon. The aircraft local area network 34 may be accessible from within the terminal, and it is not necessary for the passenger PED 38 to be located physically within the aircraft 10. The transfer of the segments 68 of the multimedia content begin once the connection is established between the data loading client 94 and the IFEC loading application 75. As in the first embodiment, the data loading client 94 may be part of the content loading application 90. The transfer of the multimedia content from the various passenger PEDs 38 may be staggered and not occur simultaneously. For example, the first segment 68a may be uploaded to the IFEC server 32 once the first passenger 88a, and hence the first passenger PED 38a, comes within the communicable range of the aircraft local area network 34, denoted in FIG. 6 as area 53. The second passenger 88b, and thus the second passenger PED 38b may board the aircraft 10 later, and the transfer of the second segment 68b accordingly begins later once in communicable range of the aircraft local area network 34.

The IFEC loading application 75 also includes the content reconstructor 86, which assembles the individual segments 68 received from the various passenger PEDs 38 into a single multimedia content file. If there are one or more segments 68 missing, the content reconstructor 86 generates an alert to this effect, which may be transmitted back to the remote content server 48. The remote content server 48 may respond to this alert by transmitting that segment 68 to a different passenger PED 38. In some embodiments, the remote content server 48 includes an IFE surveyor 106 that periodically polls the IFEC servers 32 across the entire aircraft fleet to ascertain which segments 68 have been successfully transferred from the passenger PEDs 38 to the IFEC server 32. Those segments 68 that were not successfully transferred may likewise be transmitted to a different passenger PED 38. In some cases, the re-attempt may take place directly from the remote content server 48 to the IFEC server 32 via cellular/LTE modalities or satellite modalities.

Upon receiving confirmation of a successful transfer of the multimedia content from the IFEC loading application 75, the content loading application 90 may in response delete the transferred segments 68 from the content storage 66. Alternatively, the segments 68 may be retained in the content storage 66 until a specific command from the IFEC loading application 75 is received by the content loading application 90. It is also possible for the remote content server 48 to issue the deletion command to the passenger PED 38, either by itself or by transmitting the command to the IFEC loading application 75.

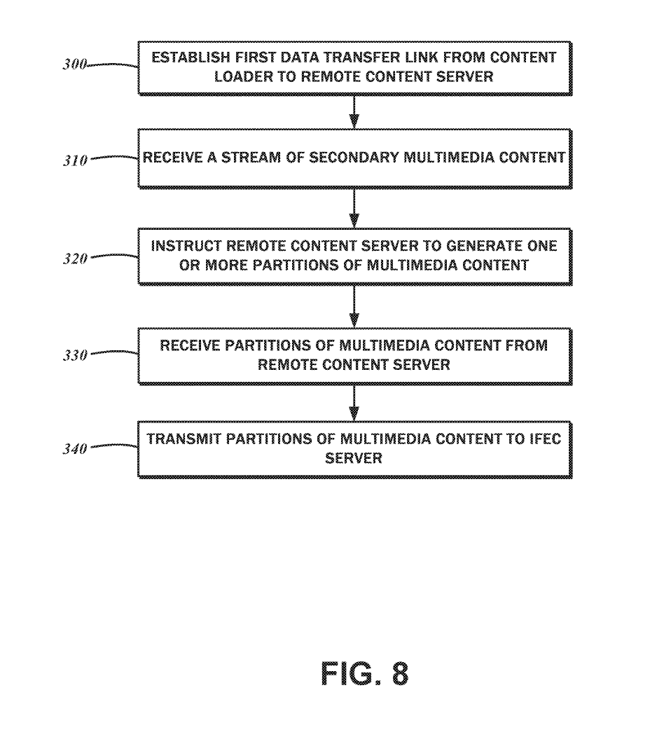

Based upon the foregoing second embodiment of the content loading system, various embodiments of the present disclosure also contemplate a method for distributing multimedia content to the IFEC system 18. As shown in the flowchart of FIG. 8, the method begins with a step 300 of establishing a first data transfer link from the content loader 54b to a content server computer system, e.g., the remote content server 48. This is understood to correspond to the aforementioned sequence of steps beginning with the passenger 88 invoking the content loading application 90 as well as the streaming client 96, signaling the availability of the passenger PED 38 to receive incoming multimedia content for transfer to the IFEC server 32. The first data transfer link in this context is understood to encompass the various wireless data communications modalities discussed above such as Wi-Fi, LTE/cellular, and the like.

The method continues with a step 310 of receiving, on the content loader 54b and over a content streaming link between the streaming client 96 and the streaming server 98, a stream of secondary multimedia content. The various modalities for streaming multimedia content were briefly mentioned above as conventional systems known in the art, so additional details thereof will be omitted. Although one embodiment of the method specifically utilizes the secondary multimedia content as the incentive for accepting the data for the IFEC server 32, other embodiments contemplate different incentives.

There is also a step 320 of instructing the remote content server 48 to generate one or more partitions or segments 68 of the multimedia content. This instruction may take the form of a simple confirmation that streaming is proceeding successfully, rather than an explicit instruction to generate the segments 68. Furthermore, it is also possible for the segments 68 to be pre-generated, in which case the instruction may correspond to a status indicator, flag, or other data construct that signals to the remote content server 48 to make a particular segment 68 of the multimedia content to be available to the specific passenger PED 38. The segments 68 that are made available for transfer to the passenger PED 38 are understood to be based at least in part upon a predefined association between the content loader 54b and the IFEC system 18 of the aircraft. The way in which these associations may be defined have been discussed in further detail above, and will therefore not be repeated.

The method continues with a step 330 of receiving the partitions or segments 68 of the multimedia content from the remote content server 48, followed by a step 340 of transmitting the same to the IFEC server 32. There may also be a precursor step of establishing a local area network communications link between the passenger PED 38 and the IFEC server 32.

The particulars shown herein are by way of example and for purposes of illustrative discussion of the various embodiments of the content loader only and are presented in the cause of providing of what is believed to be the most useful and readily understood description of the principles and conceptual aspects thereof. In this regard, no attempt is made to show more details than are necessary for a fundamental understanding of the disclosure, the description taken with the drawings making apparent to those skilled in the art how the several forms of the presently disclosed illumination module may be embodied in practice.

1. A content loader device for transferring data from a remote content server to an entertainment system of a vehicle, the content loader device comprising:
a content memory;
a primary data networking module that establishes a local data transfer link to the entertainment system while being within direct wireless communicable range thereto, and a primary remote data transfer link to the remote content server while being beyond direct wireless communicable range to the entertainment system;
a data retrieval client linked to the content memory and the primary data networking module, the data retrieval client initiating a retrieval of the data over the primary remote data transfer link based at least in part upon a predefined association of the content loader device to the vehicle, the retrieved data being stored in the content memory; and
a data loading client linked to the content memory and the primary data networking module, the data loading client, in response to a detected establishment of the local data transfer link, transfers the data to the entertainment system following retrieval from the content memory.

2. The content loader device of claim 1, wherein the data comprises one or more partitions of a multimedia content data unit.

3. The content loader device of claim 2, wherein the partitions of the data unit are generated by the remote content server.

4. The content data loader device of claim 3, wherein the data retrieval client generates an operational report to the remote content server, the partitions of the data being generated by the remote content server as a function of the operational report.

5. The content loader device of claim 1, further comprising:
a secondary data networking module that establishes a secondary remote data transfer link to the remote content server;
wherein the data retrieval client, in response to a detected establishment of the secondary remote data transfer link, initiates a retrieval of the data over the secondary remote data transfer link based at least in part upon the predefined association of the content loader device to the vehicle, the retrieved data being stored in the content memory.

6. (canceled)

7. The content loader device of claim 1, wherein the data is removed from the content memory following a completed transmission of the data to the entertainment system.

8. The content loader device of claim 1, wherein the data is removed from the content memory in response to a deletion instruction from the remote content server.

9. The content loader device of claim 1, further comprising:
a streaming client in communication with a content streaming server to retrieve secondary data for playback during the retrieval of the data from the remote content server.

10. A system for wirelessly distributing data to an in-flight entertainment system of an aircraft, the system comprising:
a remote content server on which the data is stored, the data being segregated into one or more partitions; and
one or more content loader devices each associated with an individual scheduled for travel on the aircraft, and each including:
a data retrieval module that initiates a transfer of the one or more partitions of the data upon establishing a first data communications link to the remote content server;
a data loading module that transfers the data to the in-flight entertainment system over a second data communications link to the in-flight entertainment system;
wherein the remote content server defines and designates the one or more partitions of the data for transfer to a specific one of the content loader devices based at least in part upon a predefined association between the specific one of the content loader devices and the aircraft.

11. The system of claim 10, wherein the data comprises multimedia content data, the system further comprising:
a multimedia streaming server with secondary multimedia content data stored thereon, the secondary multimedia content data being streamed to the one or more content loader devices;
wherein the one or more content loader devices each include a multimedia streaming client in communication with the multimedia streaming server, the secondary multimedia content data being streamed to the content loader device for playback thereon, and the transfer of the one or more partitions of the multimedia content data being initiated in response to initiating the streaming of the secondary multimedia content data.

12. The system of claim 10, wherein the remote content server segregates the data into one or more partitions based at least in part upon the number of active content loader devices concurrently in communication with the remote content server over respective first data communications links.

13. The system of claim 10, wherein the designation of the one or more partitions of the data for transfer to the specific one of the content loader devices is based at least in part upon an estimated time to board the aircraft by the individual to which the content loader device is associated.

14. The system of claim 10, wherein the remote content server polls the in-flight entertainment system on a periodic for a report of the one or more partitions of the data transferred to the in-flight entertainment system of the aircraft from the content loader devices.

15. The system of claim 10, wherein the in-flight entertainment system reconstructs the data from the partitions transferred from the content loader devices.

16. The system of claim 15, wherein the in-flight entertainment system reports to the remote content server during the reconstruction of the data missing partitions therein not yet received from any of the content loader devices.

17. The system of claim 10, wherein the one or more partitions of the data stored on the content loader devices are deleted following a completed transfer to the in-flight entertainment system.

18. The system of claim 10, wherein the one or more partitions of the data stored on the content loader devices are deleted in response to a deletion command generated by the remote content server.

19. A method for distributing data to an in-flight entertainment system of an aircraft, the method comprising:
establishing a first data transfer link from a content loader device to a content server computer system;
receiving, on the content loader device over a content streaming link, a stream of secondary data from a streaming server computer system;
instructing the content server computer system to generate one or more partitions of a data in response to initiating the streaming of the secondary data to the content loader device, the generating of the one or more partitions being based at least in part upon a predefined association between the content loader device and the in-flight entertainment system of the aircraft;
receiving, by the content loader device, the partitions of the data generated by the content server computer system; and
transmitting the one or more partitions of the data to the in-flight entertainment system over a second data transfer link from the content loader device to the in-flight entertainment system.

20. The method of claim 19, further comprising:
deleting the one or more partitions of the data stored on the content loader devices in response to a deletion command generated by the remote content server.

21. The method of claim 19, wherein said data comprises multimedia content.
